(19) United States
(12) Patent Application Publication
(10) Pub. No.: US 2015/0090918 A1
(43) Pub. Date: Apr. 2, 2015

(54) Control Valve for Vacuum Systems

(71) Applicants: Brian Scott SMIDDY, Newburgh, IN (US); Jonathan Fuquay, Boonville, IN (US)

(72) Inventors: Brian Scott SMIDDY, Newburgh, IN (US); Jonathan Fuquay, Boonville, IN (US)

(73) Assignee: Thermwood Corporation, Dale, IN (US)

(21) Appl. No.: 13/908,241

(22) Filed: Jun. 3, 2013

(51) Int. Cl. F16K 1/44

(52) U.S. Cl. CPC F16K 1/44
USPC 251/324

(57) ABSTRACT

A valve assembly including a housing having first and second ports; a cylinder assembly mounted on such housing having a piston rod displaceable along an axis of such first port, provided with a valve plug including a first component having a passageway therethrough intercommunicable with the interior of such housing and such first port, and a second component supported on and displaceable axially relative to such first component, wherein upon extension of such plug into closing engagement with such first port, such passageway will be obstructed and upon retraction of such plug out of closing engagement with such first port, such passageway will be unobstructed.

This invention relates to a control valve and more particularly to a valve disposable in a vacuum line operable to facilitate the opening thereof under negative pressure conditions.

### BACKGROUND OF THE INVENTION

Computer numerical control (CNC) machine tools such as routers used in the woodworking, plastics and nonferrous metal industries, typically consist of a base unit, a stationary or movable workpiece support table mounted on a base unit, a stationery or movable gantry mounted on or adjacent to the base unit, and a toolhead assembly mounted on a transversely disposed bridge member of the gantry. Either the table or the gantry is displaceable relative to the base unit longitudinally or along an x-axis, the toolhead assembly is displaceable transversely or along a y-axis and the toolhead is displaceable vertically or along a z-axis. Each are displaced along their respective axes by feedscrews driven by servomotors. The motions of the various components of the machine are controlled by a controller, which operates the various servomotors of the machine according to instructions of a program inputted into the controller.

Workpieces to be machined are positioned on the table in predetermined locations, and are held down by various means including clamps and vacuum systems. Vacuum systems may consist of conventional systems which provide high vacuum, suitable for large production runs, and universal systems which are more suitable for short production runs. A conventional vacuum system generally includes a vacuum port provided in the worktable, connected to a vacuum pump and a vacuum fixture positioned on the workpiece table about the vacuum port on which the workpiece is positioned. The fixture is provided with a peripheral rubber seal engaged by the workpiece seated thereon, which permits the evacuation of air between the fixture and the workpiece to hold the workpiece in place.

A universal vacuum system also known as a high-flow system, generally includes a table having a lower rigid plate, an arrangement of spacers attached thereto in a grid pattern, a perimeter wall, an upper spoil board formed of a porous material such as particleboard supported on such spacers and perimeter wall, closing the spacer grid area to form a plenum, a vacuum pump operatively connected to the plenum, and a valve for turning the vacuum on and off. As a vacuum is applied to the plenum, air is drawn through the porous upper board material, producing a low pressure zone at the surface, which functions to hold a workpiece positioned thereon. The universal system does not require any special fixtures or gaskets, thus requiring less time and expense to maintain. It is therefore more desirable to use this method when possible.

The high-flow system requires a relatively high volume of air movement, in the order of 300 to 500 cubic feet per minute, in order to maintain an adequate level of vacuum at the worktable surface. Piping components in the 4-inch diameter range are required to sufficiently move such a high volume of air through the system.

The valve arrangement in such a system is oftentimes problematic. It is essential that the vacuum control valve be capable of automatic remote operation. In order to achieve this objective, numerous devices are employed throughout the industry, such as a pneumatically operated throttle valve, or an expensive air-piloted electric solenoid valve, to name a few. The methods employed in the prior art have proven to be either problematic, or excessively expensive.

One of the most efficient types of valves for this use is the plug type valve. The plug type valve employs a single pneumatic action to drive a full-diameter gate or plug, into a conical valve seat, the sloping surface of which faces the valve body interior. The valve seat has an open cross-sectional port area equal to the diameter of the piping in the system, thus negating any limitation in the air-flow through the system. Such a valve is fast-operating, requiring only a single stroke to extend or retract the plug into or out of the valve seat. An additional advantage of such a valve, when employed in vacuum service, is the natural ability of the plug to self-seal. The system's vacuum pump generates a high level of vacuum, holding the gasketed plug tight against the port, with little or no effort from the operating means, once the plug is thrust into place. This provides for a near perfect seal. There is however, a major obstacle to overcome when employing this type of valve in vacuum service. The breakaway force required to separate the plug from the valve seat is quite substantial. This is due to the high level of vacuum acting on the plug, coupled with the plug's relatively large diameter. Overcoming this degree of resistance requires an expensive and cumbersome actuating means. The present invention serves to overcome the insufficiencies of prior art by providing a dual-element valve, which utilizes a primary gate type sub-valve to break the initial vacuum.

### SUMMARY OF THE INVENTION

The deficiencies of the prior art as stated are overcome by the present invention by providing a valve assembly generally including a housing with a first port disposed on an axis and having a peripheral seating surface, and a second port; a cylinder assembly including a cylinder mounted on such housing and a piston rod displaceable along such axis; and a valve plug including a first component having a passageway therethrough intercommunicable with the interior of such housing and such first port, and a second component supported on and displaceable axially relative to such first member, wherein upon full extension of such piston rod, such first component is caused to displace such second component into sealing engagement with such peripheral seating surface of the housing and correspondingly mask a port of such passageway, and upon a limited retraction of such piston rod from a full extension thereof, the port of such passageway is caused to unmask as such second component remains intact, relieving the negative pressure urging the second component in sealing engagement and permitting the retracting force applied to the piston rod to unseat the second component. In a preferred embodiment of the invention, the first component mounted on the piston rod, is provided with a pair of opposed, forwardly and rearwardly facing abutment surfaces, and a passageway including an inlet port disposed in a leading surface thereof, communicable with such conduit, and an outlet port rearwardly disposed relative to such first port, communicable with such first port; and a second component mounted on such first component, engageable by the rearward abutment surface of the first component upon extension of the piston rod to displace the second component into sealing engagement with such seating surface, masking the outlet port the passageway, and engageable by the forward abutment surface of the first component upon retraction of the piston rod, to displace the second component, unmasking the outlet port of the passageway.

### BRIEF DESCRIPTION OF THE DRAWINGS

FIG. 1 is a side view of the valve assembly embodying the present invention mounted in a vacuum system, having a portion thereof broken away and illustrating the plug portion of the valve in an open position;

FIG. 2 is a view similar to the view shown in FIG. 1, illustrating the valve plug in a fully closed position;

FIG. 3 is a view similar to the view shown in FIGS. 1 and 2 illustrating the valve plug in a partially open condition;

FIG. 4 is a prospective, exploded view of the housing and valve shown in FIGS. 1 through 3;

FIG. 5 is a perspective view of the valve plug of the invention in the assembled condition; and

FIG. 6 is a view of the components of the valve plug shown in FIG. 5 illustrated in exploded relation.

### DETAILED DESCRIPTION OF THE PREFERRED EMBODIMENT OF THE INVENTION

Referring to the drawings, there is illustrated a valve assembly including a housing 10 on which there is mounted a cylinder assembly 11 provided with a plug assembly 12. Housing 10 has a T-shaped configuration including a cylindrical section 13 provided with a closed end cap 14 and an outlet opening 15, and a cylindrical section 16 disposed orthogonally relative to the axis of section 13 and providing an inlet port 17. A conduit 18 is received in and connected to outlet port 15 at one end thereof and connected at an opposite end thereof to a vacuum pump (not shown). A conduit 19 is received in and connected to inlet port 17 at one end thereof and connected at an opposite end thereof to a chamber to be evacuated such as a chamber below a porous particleboard of a CNC router functional to hold down workpieces to be machined. Disposed in housing section 13 adjacent outlet port 15 is an annular member 20 provided with a frusto-conically configured seating surface 21.

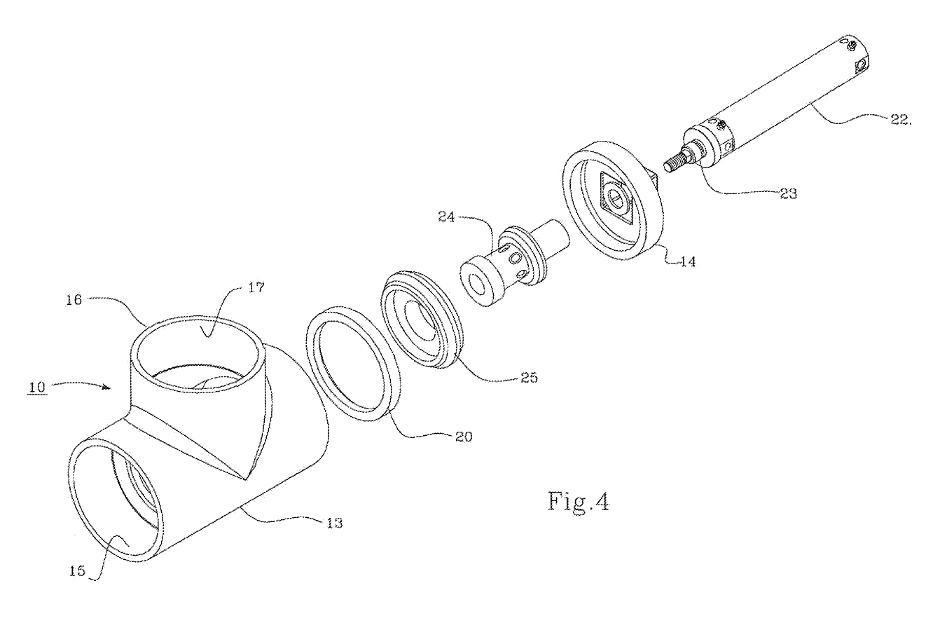

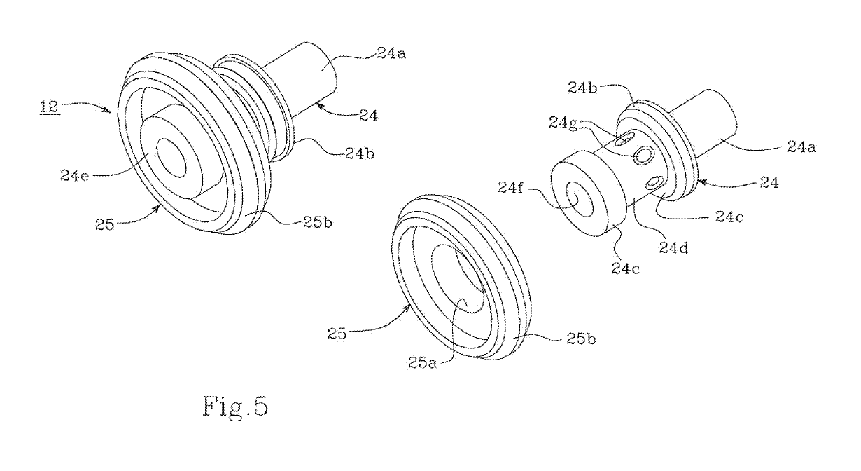

Cylinder assembly 11 includes a cylinder 22 mounted on a projected portion 14a of housing end wall 14, coaxially with housing cylindrical section 13, and a piston rod 25. As best shown in FIGS. 4 through 6, valve plug assembly 12 is mounted on the free end of the piston rod and includes a base member 24 mounted axially on the free end of the piston rod and a disc member 25 displaceably mounted on such base member. Base member 24 includes a cylindrical segment 24a provided with an axially disposed, threaded opening in an end face thereof which is threaded onto the free end of piston rod 23, an annular flange segment 24b having a forwardly facing annular surface 24c, an annular segment 24d and an annular flange segment 24e axially spaced from annular segment 24d. The forwardly facing surface of flange segment 24e is provided with an axially disposed recess 24f which communicates with a set of radially disposed, circumferentially spaced ports 24g in segment 24d, adjacent to annular surface 24c, providing a passageway through segment 24.

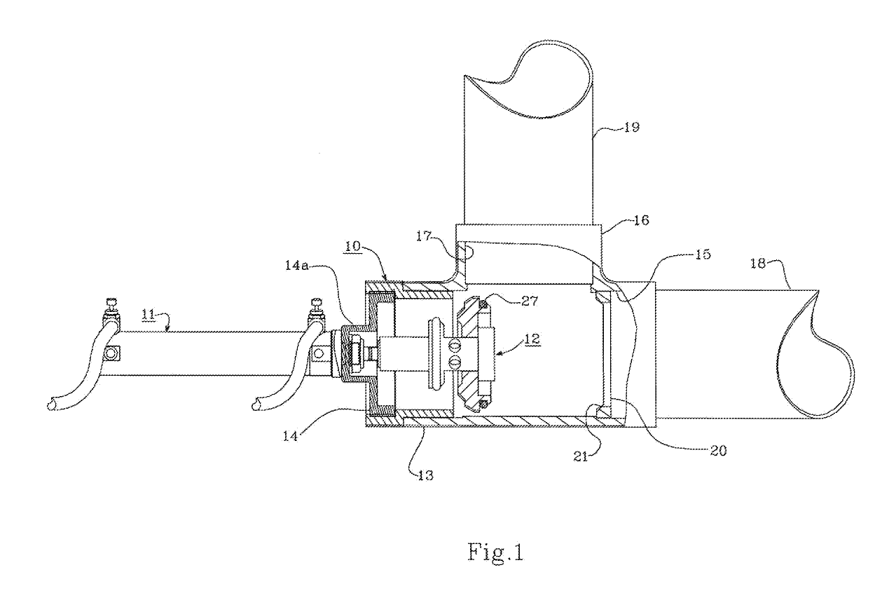

Disk member 25 is mounted on segment 24d of base member 24 and is displaceable between annular flange segments 24b and 24e. Axial opening 25a of the disc member is provided with a diameter sufficient to permit the disc to freely displace between segments 24e and 24b. The thickness of the disc member is such so that when it is in a rearwardly disposed position abutting surface 24c, it masks ports 24g, blocking the passageway through the base member, and when in a forwardly disposed position abutting the rearwardly facing surface of segment 24e, it unmasks such ports. Disk member 25 further is provided with a frusto-conically configured leading surface 25b on which there is provided an O-ring sealing gasket 27, as best shown in FIG. 1.

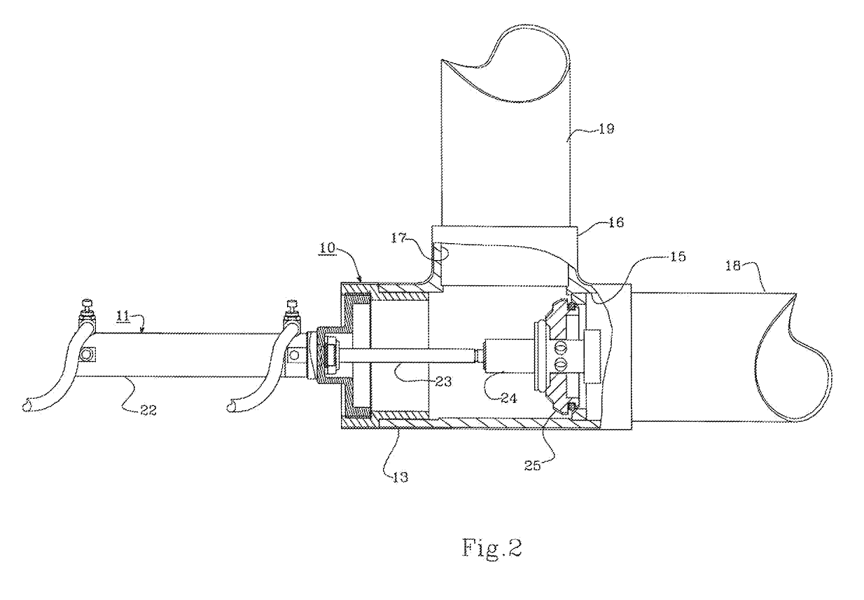

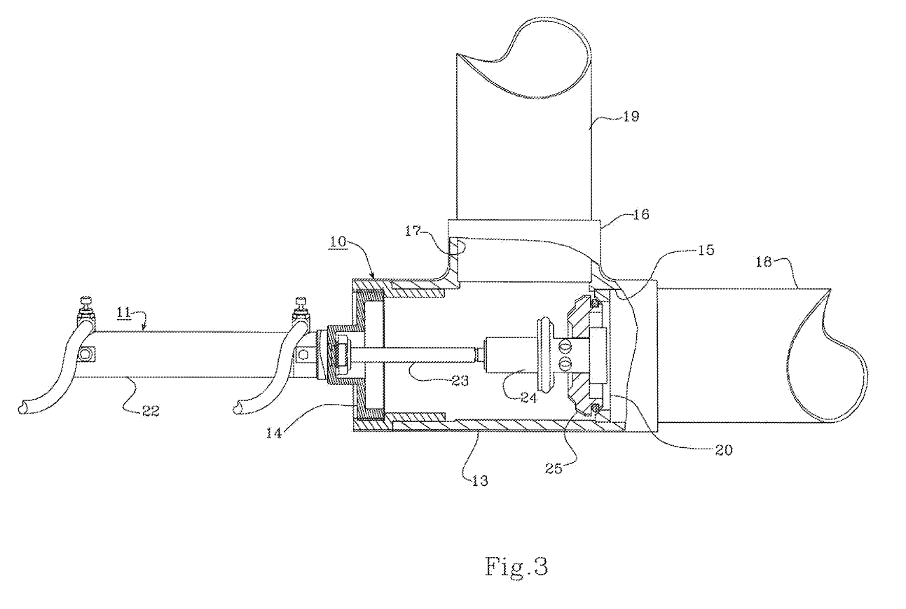

With the piston rod of the cylinder assembly fully retracted as shown in FIG. 1 and the vacuum pump connected to conduit 18 operating, plug assembly 12 will be sufficiently retracted to permit free flow between conduits 18 and 19 through outlet port 15 and inlet port 17. When it is desirable to close outlet port 15, the piston rod is extended to cause annular flange segment 24b of member 24 to engage and displace the disk member to the position shown in FIG. 2 with gasket 27 engaging seating surface 21 in sealing engagement, and thus mask ports 24g, blocking passage through base member 24. When it is decided to open the valve assembly with the vacuum pump operating, the cylinder assembly is operated to partially retract the piston rod to the position shown in FIG. 3, with ports 24g of the base member no longer being masked, providing a passageway between ports 15 and 17. The opening of the passageway through base member 24 functions to reduce the negative pressure in conduit 18 thus reducing the amount of force required by the cylinder assembly to retract the piston rod to position the valve assembly as shown in FIG. 1, allowing an unimpeded passage of air through the valve housing, applying a negative pressure in the chamber of the machine provided with a porous particle board on which a workpiece is positioned.

With a negative pressure having been applied to conduit 18 with the plug assembly disposed in the closed position as shown in FIG. 2 and the vacuum pump operating, a substantial amount of force is required for the cylinder assembly to unseat the valve assembly. By providing for a passageway through the cylinder assembly while it is in the closed position as shown in FIG. 3, a reduced force is required for the valve assembly to fully unseat the valve assembly and retract the assembly to the position as shown FIG. 1, providing an unimpeded passage between conduits 18 and 19.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

We claim:

1. A valve assembly comprising:
a housing provided with a first port disposed on an axis and having a peripheral seating surface, and a second port;
a cylinder assembly including a cylinder mounted on said housing and a piston rod displaceable along said axis; and
a valve plug including a first component having a passageway therethrough intercommunicable with the interior of said housing and said first port, and a second component supported on and displaceable axially relative to said first member,
wherein upon full extension of said rod, said first component is caused to displace said second component into sealing engagement with said peripheral seating surface of said housing and correspondingly mask a port of said passageway, and upon a limited retraction of said rod from a full extension thereof, said port of said passageway is caused to unmask as said second component remains intact.

2. An assembly according to claim 1 wherein said first port is communicable with a negative pressure producing source and said second port is communicable with a chamber to be depressurized.

3. An assembly according to claim 2 wherein said negative pressure producing source comprises a vacuum pump and said chamber is provided with a porous bed upon which workpieces to be treated may be positioned and detachably secured by negative pressure.

4. An assembly according to claim 3 wherein said assembly comprises a component of a hold-down system for the worktable of a CNC router machine.

5. An assembly according to claim 2 wherein an operating system of said cylinder assembly is operable upon full extension of said rod and corresponding closure of said first port, under a negative pressure, to sufficiently retract said first component of said valve plug to unmask said passageway port, thus correspondingly reducing the negative pressure biasing said valve plug in the closed position, correspondingly reducing the amount of force required by the cylinder assembly to fully retract said valve plug.

6. An assembly according to claim 1 wherein said valve plug is retractable beyond said second port providing intercommunication between said first and second ports of said housing.

7. An assembly according to claim 1 wherein said housing includes a first cylindrical conduit defining said axis, having a closed end on which said cylinder of said cylinder and piston rod assembly is mounted with the rod thereof extending through an opening in said end wall and the valve plug thereof disposed therein and engageable with said peripheral seating surface defining said first port, and a second conduit disposed to an angle to said axis and connected to said first cylindrical segment providing said second port.

8. An assembly according to claim 7 including a sealing gasket disposed on said valve plug.

9. A valve plug mountable on the piston rod of a cylinder assembly mounted on a housing provided with a first port communicating with a conduit, having a seating surface relative to the axis of travel of said rod, and a second port disposed between said first port and said cylinder, comprising:
a first component mounted on said piston rod, provided with a pair of opposed, forwardly and rearwardly facing abutment surfaces, and a passageway including an inlet port disposed in a leading surface thereof communicable with said conduit and an outlet port rearwardly disposed relative to said first port, communicable with said second port; and
a second component mounted on said first component, engageable by said rearward abutment surface of said first component upon extension of said rod to displace said second component into sealing engagement with said seating surface, masking said outlet port of said passageway, and engageable by said forward abutment surface of said first component upon retraction of said rod, to displaced said second component, unmasking said outlet port of said passageway.

10. A valve plug according to claim 9 wherein said second component is provided with a peripheral seal engageable in sealing relation with said seating surface upon extension of said piston rod.

11. A valve plug according to claim 9 wherein said first component includes a cylindrical segment disposed coaxially with said piston rod, and a pair of axially spaced annular flange segments providing said forwardly and rearwardly disposed abutment surfaces, and said second component comprises a disk freely mounted on said cylindrical segment of said first component and engageable with said abutment surfaces upon extension and retraction of said piston rod.

12. A valve plug according to claim 11 wherein said disk is provided with an annular seal engageable in sealing engagement with said seating surface upon extension of said piston rod.

13. A valve plug according to claim 11 wherein said inlet of said passageway is disposed in a leading face of one of said cylindrical and annular flange segments, and said outlet of said passageway is disposed on a face of one of said cylindrical segment and the other of said annular flange segments.

14. A valve plug according to claim 11 wherein said passageway includes an axially disposed recess in a leading face of said cylindrical segment providing said inlet port, and a radially disposed recess in a side of said cylindrical segment between said annular flange segments, providing said outlet port, intercommunicating said recesses.

15. A valve head according to claim 14 including a plurality of circumferentially spaced, radially disposed portions of said passageway, each provided with an outlet port.
